(19) United States
(12) Patent Application Publication
(10) Pub. No.: US 2011/0318586 A1
(43) Pub. Date: Dec. 29, 2011

(54) Innovative flexible packaging forms, method for producing them and use thereof

(75) Inventors: Ana Maria Cano Sierra, Heidelberg (DE); Christian Scheffner, Mannheim (DE); Andrea Fruth, Wiesbaden (DE); Bruce Ernst, Weinheim (DE)

(73) Assignee: RHEIN CHEMIE RHEINAU GMBH, Mannheim (DE)

(21) Appl. No.: 13/115,561

(22) Filed: May 25, 2011

(30) Foreign Application Priority Data
Jun. 2, 2010 (EP) 10164744.4
Feb. 7, 2011 (EP) 11153498.8

(51) Int. Cl. B32B 27/08; B32B 27/34; B32B 27/36; B32B 15/08; B32B 27/28; B32B 27/30; B32B 27/32; B32B 37/12; B32B 27/40; C09J 177/00; C09J 175/04; C09J 123/00; C09J 167/00; C09J 133/08; C09J 171/00; B32B 9/04

(52) U.S. Cl. 428/423.1; 428/704; 428/474.4; 428/480; 428/457; 428/458; 428/474.7; 428/475.2; 428/483; 428/500; 428/522; 156/331.1; 156/331.4; 156/334; 156/332; 156/327

(57) ABSTRACT

The invention relates to innovative flexible packaging forms comprising at least 2 different layers of material joined by means of one or more adhesive layers, at least one of these adhesive layers comprising a carbodiimide or a mixture of two or more carbodiimides, to a method for producing them and to the use thereof.

### CROSS REFERENCE TO RELATED PATENT APPLICATIONS

The present patent application claims the right of priority under 35 U.S.C. §119 (a)-(d) of European Patent Application No. 10164744.4 filed Jun. 2, 2010, and European Patent Application No. 11153498.8, filed Feb. 7, 2011, incorporated herein by reference.

The invention relates to innovative flexible packaging forms comprising at least 2 different layers of material joined by means of one or more adhesive layers, at least one of these adhesive layers comprising a carbodiimide or a mixture of two or more carbodiimides, to a method for producing them and to the use thereof.

Flexible packaging forms are acquiring ever greater significance, as in the case, for example of flexible plastics assemblies, vacuum pouches, co-extruded plasticized films, etc.

For example, U.S. Pat. No. 7,414,091 discloses polyurethane-based adhesives, or, from U.S. Pat. No. 5,731,090, multilayer packaging forms comprising OH-terminated polyester and isocyanate, which are utilized, for example, as pouches.

A disadvantage of these systems is that they are sensitive to hydrolysis, and this greatly restricts the range for application, and limits the service life.

There is therefore a need for flexible packaging forms comprising at least 2 different layers of material that exhibit a significantly increased stability particularly in respect of hydrolysis and that therefore possess a longer service life.

It was an object of the present invention, therefore, to provide new flexible packaging forms which do not have disadvantages of the prior art.

The object on which this invention was based has been achieved by means of the innovative flexible packaging forms of the invention, which are composed of at least 2 different layers of material joined by means of one or more adhesive layers, at least one of these adhesive layers comprising a carbodiimide or a mixture of two or more carbodiimides.

The present invention accordingly provides innovative flexible packaging forms comprising at least 2 different layers of material which are joined by means of one or more adhesive layers, characterized in that at least one of these adhesive layers comprises a carbodiimide or a mixture of two or more carbodiimides of the formula (I)

R′—(—N═C═N—R′″)ₘ—R″ (I),
in which
R′″ is an aromatic and/or araliphatic radical and, where m≧1, R′″ within the molecule is alike or different and, in the case of different combinations, each of the aforementioned radicals may be combined arbitrarily with one another,
R′″ in the case of an aromatic radical or araliphatic radical can carry no, or in at least one ortho-position to the aromatic carbon atom which carries the carbodiimide group, can carry aliphatic and/or cycloaliphatic substituents having at least 2 carbon atoms, preferably may carry branched or cyclic aliphatic radicals having at least 3 carbon atoms, more particularly isopropyl groups, which may also carry heteroatoms which also heteroatoms as such as, for example N, S and/or O, or else imidazolyl,
R′=C₁-C₁₈-alkyl, C₅-C₁₈-cycloalkyl, aryl, C₇-C₁₈-aralkyl, —R—NHCOS—R¹, —R—COOR¹, —R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or —R—NHCOOR³, where
R=aromatic, aliphatic, cycloaliphatic and/or araliphatic radical,

R″=H, —N═C═N-aryl, —N═C═N-alkyl, —N═C═N-cycloalkyl, —N═C═N-aralkyl, —NCO,
—NHCONHR¹, —NHCONR¹R², —NHCOOR³, —NHCOS—R¹, —COOR¹, —OR¹, —N(R¹)₂,
—SR¹, —OH, —NH₂, —NHR¹,
where, in R′ and R″ independently of one another, R¹ and R² are alike or different and are a C₁-C₂₀-alkyl-, C₃-C₂₀-cycloalkyl, -aryl, C₇-C₁₈-aralkyl radical, oligo-/polyethylene glycols and/or -propylene glycols and R³ has one of the definitions of R¹ or is a polyester radical or a polyamide radical, and m corresponds to an integer from 1 to 5000,
and/or of formula (II)

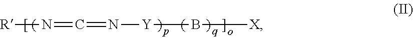

where
Y═C₁-C₁₈-alkylene, C₅-C₁₈-cycloalkylene, arylene, C₇-C₁₈-aralkylene,
p=an integer from 1 to 500, preferably 1 to 100,
B=—NH—CO—NH—Z—, —NH—COO—Z—, —NH—COS—Z—,
q=an integer from 1 to 500, preferably 1 to 100,
o=an integer from 1 to 500, preferably 1 to 100,
X═H, —OH, —SH, —NH₂, —OR¹, —N(R¹)₂, —SR¹, —NHR¹, NR¹R², —OCO—NH—R′, NH CO—, —NH—R′, —S—CO—NH—R′
R′=C₁-C₁₈-alkyl, C₅-C₁₈-cycloalkyl, aryl, C₇-C₁₈-aralkyl
   —R′″—NH—COS—R¹, —R′″—COOR¹, —R′″—OR¹, R′″—N(R¹)₂,
   R′″—SR¹, —R′″—OH, —R′″—NH₂, —R′″—NHR1, —R′″-epoxy,
   R′″—NCO, —R′″—NHCONHR¹, —R′″—NHCONR¹R² or —R′″—NH—COOR³,
where
R¹ and R² are alike or different and a C₁-C₂₀ alkyl, C₃-C₂₀-cycloalkyl, aryl, C₇-C₁₈-arylkyl radical, oligo-/polyethylene glycols and/or propylene glycols and R³ has one of the definitions of R¹ or is a polyester radical or a polyamide radical, such as, for example acetate- or butyl- and/or benzoic ester and
Z=Y, -polyester-, -polyether- and/or -polyamide-, and R′″ is an aromatic and/or araliphatic radical,

In relation to the preferred embodiment of R′″ reference is made to the recitations above.

Particularly preferred in this context are aromatic and sterically hindered carbodiimides and/or arylaliphatic sterically hindered and/or aliphatically sterically unhindered carbodiimides of the above-stated formula (I).

Particularly suitable, moreover, are carbodiimides of the general formula (III),

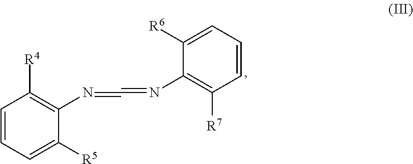

in which R⁴ to R⁷ independently of one another is linear or branched C₁-C₂₀-alkyl, C₃- to C₂₀-cycloalkyl, C₆-C₁₅-aryl or a C₆-C₁₅-aralkyl radical, which optionally may also contain heteroatoms, such as for example N, S or O.

The radicals R⁴ to R⁷ preferably correspond to C₂-C₂₀-alkyl or C₃-C₂₀-cycloalkyl radicals.

With very particular preference, the radicals R⁴ to R⁷ correspond to C₂₋ to C₂₀-alkyl radicals.

Furthermore, it is also possible to use polymeric aliphatic carbodiimides, based for example on isophorone diisocyanate or dicyclohexylmethane 4,4′-diisocyanate (H12-MDI=hydrogenated MDI).

Likewise possible for use are biobased carbodiimides, obtainable from the reaction of at least one of the aforementioned carbodiimides having at least one free N—C—O functionality and an H-acidic compound isolated from renewable raw materials or prepared therefrom, and/or a hydroxycarboxylic ester having 2-24 carbon atoms.

The layers of material in the sense of the invention may comprise all common polymers. These are, preferably, polyethylene terephthalate, polyamides, polyolefins, such as, for example, polypropylene and/or polyethylene, and also aluminium foils.

In the flexible packaging forms of the invention it is important that the different layers of material are joined to one another by an adhesive layer. Here, 2-10 different layers of material may be utilized. Likewise possible is a sandwich-like layering of 2 or more different layers of material, in the following sequence, for example:

Material layer 1-adhesive layer-material layer 2-adhesive layer-material layer 1-adhesive layer-material layer 2 or
Material layer 1-adhesive layer-material layer 2-adhesive layer-material layer 1-adhesive layer-material layer 3, etc.

In another preferred embodiment of the invention, in those cases where two or more adhesive layers exist, at least one of these adhesive layers comprises a carbodiimide or a mixture of two or more carbodiimides. With very particular preference, all of the adhesive layers in the flexible packaging forms comprise a carbodiimide or a mixture of two or more carbodiimides of the formulae (I), (II) and/or (III).

With regard to the adhesive layer in the sense of the invention, common polymeric adhesive systems, such as solvent-based and/or water-based, solvent-free and/or UV-curing systems, may be used, which now, in the sense of the invention, additionally comprise a carbodiimide or a mixture of two or more carbodiimides of the formulae (I), (II) and/or (III). The carbodiimide-free polymeric adhesive systems are available commercially, as from C.O.I.M for example.

The polymeric adhesive systems preferably comprise preferably polymeric systems which are selected from the group consisting of polyamides, copolyamides, polyolefins, ethylene-vinyl acetate copolymers, polyurethanes, thermoplastic polyurethanes (TPU), polyesters, polyacrylates and/or vinylpyrrolidone/vinyl acetate copolymers, polyester-urethanes, acrylates, polyethers and/or polyether-urethanes which further comprise a carbodiimide or a mixture of two or more carbodiimides.

The present invention therefore further provides flexible packaging forms in which the carbodiimide used is obtainable from the reaction of at least one carbodiimide of the formula (I) and/or (II), which possesses at least one free N—C—O functionality with at least one H-acidic compound which is isolated from renewable raw materials or prepared therefrom, and/or with a hydroxycarboxylic ester having 2-24 carbon atoms.

The hydroxycarboxylic esters in the sense of the invention are preferably hydroxycarboxylic esters having 2-24 carbon atoms such as, for example polylactic acid and/or polyhydroxybutyrates of the formula (IV)

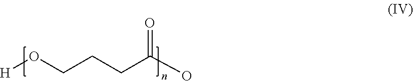

where n=2-20.

The H-acidic compounds isolated from renewable raw materials are preferably natural polyols, such as, for example, castor oil, starch and/or sugars. The aforementioned compounds are commercially available substances.

The H-acidic compounds prepared from renewable raw materials are preferably glycerol, polyols from vegetable oils, such as, for example, rapeseed oil, soya oil and/or from unsaturated fatty acids, such as, for example, oleic acid.

The above-stated compounds are commercially available substances which are available from, for example, the companies Cargill and/or Urethane Soy Systems.

Conversion from plant oils and/or from unsaturated fatty acids may take place in accordance with the methods that are familiar to the skilled person, such as, for example, by ozonization with subsequent glycolysis, epoxidation with subsequent ring opening by alcohols, for example, or hydroformylation and subsequent reduction with hydrogen.

In relation to the biobased carbodiimides and their preparation, reference is made to the applications DE-A 102009001130.7 and EP 10163621.5, the content of which is hereby incorporated into this application.

The term “biobased carbodiimides” refers to carbodiimides which have a fraction of more than 7% of a biobased raw material.

The above-stated carbodiimides are commercially available compounds which are available commercially from, for example Rhein Chemie Rheinau GmbH under the trade names Stabaxol® I (N—C—N content: 10%), Stabaxol® P (N—C—N content: 12.5-13.5%) and Stabaxol® P 200 (N—C—N content: 6-7.5%).

Likewise possible as well is the preparation of the carbodiimides by the processes described in

U.S. Pat. No. 2,941,956, for example, or by the condensation of diisocyanates with elimination of carbon dioxide at elevated temperatures, e.g. at 40° C. to 200° C., in the presence of catalysts. Suitable processes are described in DE-A-11 30 594 and in FR 1 180 370. Examples of catalysts which have been found appropriate are strong bases or phosphorus compounds. Preference is given to using phospholene oxides, phospholidines or phospholine oxides and also the corresponding sulphides. As catalysts it is possible, furthermore, to use tertiary amines, metal compounds which give a basic reaction, metal salts of carboxylic acids, and non-basic organometallic compounds.

For preparing the carbodiimides and/or polycarbodiimides that are used, suitability is possessed by all isocyanates, with preference being given in the context of the present invention to use of carbodiimides and/or polycarbodiimides which are based on aromatic-isocyanates substituted by C₁- to C₄₋alkyl, such as, for example, 2,6-diisopropylphenyl-isocyanate, 2,4,6-triisopropylphenyl-1,3-diisocyanate, 2,4,6-triethylphenyl-1,3-diisocyanate, 2,4,6-trimethylphenyl-1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanatodiphenylmethane, tetramethylxylene-diisocyanate, 1,5-naphthalene-diisocyanate, 4,4′-diphenylmethane-diisocyanate, 4,4′-diphenyldimethylmethane-diisocyanate, 1,3-phenylene-diisocyanate, 1,4-phenylene-diisocyanate, 2,4-tolylene-diisocyanate, 2,6-tolylene diisocyanate, a mixture of 2,4-tolylene-diisocyanate and 2,6-tolylene diisocyanate, hexamethylene-diisocyanate, cyclohexane-1,4-diisocyanate, xylylene diisocyanate, isophorone diisocyanate, dicyclohexylmethane 4,4′-diisocyanate, methylcyclohexane diisocyanate, tetramethylxylylene diisocyanate, 2,6-diisopropylphenylene isocyanate and 1,3,5-triisopropylbenzene 2,4-diisocyanate or mixtures thereof, or are based on substituted aralkyls, such as 1,3-bis(1-methyl-1-isocyanatoethyl)benzene. It is particularly preferred if the carbodiimides and/or polycarbodiimides are based on 2,4,6-triisopropylphenyl 1,3-diisocyanate and/or 2,6-diisopropylphenylene isocyanate and/or tetramethylxylylene diisocyanate.

If they have been prepared from isocyanates, polycarbodiimides may further still comprise reactive NCO groups and monomeric isocyanates attached in complex form.

In another embodiment of the present invention it is also possible to use a mixture of different carbodiimides.

The amount of carbodiimide is preferably 0.01 to 50% by weight, based on the adhesive layer.

The polymeric adhesive systems may comprise further additives in addition to the carbodiimide, such as for example, antioxidants, flame retardants, solvents, such as, for example ethyl acetate or water.

The adhesive layer used in producing the flexible packaging of the invention is prepared preferably as follows:

One or more polymeric systems which are selected from the group consisting of polyamides, copolyamides, polyolefins, ethylene-vinyl acetate copolymers, polyurethanes, thermoplastic polyurethanes (TPU), polyesters, polyacrylates and/or vinylpyrrolidone/vinyl acetate copolymers, polyester-urethanes, acrylates, polyethers and/or polyether-urethanes are admixed with at least one carbodiimide or a mixture of two or more carbodiimides and optionally further additives.

The present invention provides, moreover, a method for producing the flexible packaging forms of the invention, whereby the layer of adhesive is knife-coated onto the surface of at least one layer of material, said layer of adhesive comprising polymeric systems selected from the group consisting of polyamides, copolyamides, polyolefins, ethylene-vinyl acetate copolymers, polyurethanes, thermoplastic polyurethanes (TPU), polyesters, polyacrylates and/or vinylpyrrolidone/vinyl acetate copolymers, polyester-urethanes, acrylates, polyethers and/or polyether-urethanes, and which further comprises a carbodiimide or a mixture of two or more carbodiimides of the formula (I)

R′—(—N═C═N—R′″—)ₘ—R″ (I),

in which

R′″ is an aromatic and/or araliphatic radical and, where m≧1, R′″ within the molecule is alike or different and, in the case of different combinations, each of the aforementioned radicals may be combined arbitrarily with one another,

R′″ in the case of an aromatic radical or araliphatic radical can carry no, or in at least one ortho-position to the aromatic carbon atom which carries the carbodiimide group, can carry aliphatic and/or cycloaliphatic substituents having at least 2 carbon atoms, which may also carry heteroatoms,

R′=C₁-C₁₈-alkyl, C₅-C₁₈-cycloalkyl, aryl, C₇-C₁₈-aralkyl, —R—NHCOS—R¹, —R—COOR¹, —R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or —R—NHCOOR³, where R=aromatic, aliphatic, cycloaliphatic and/or araliphatic radical,

R″=H, —N═C═N-aryl, —N═C═N-alkyl, —N═C═N-cycloalkyl, —N═C═N-aralkyl, —NCO, —NHCONHR¹, —NHCONR¹R², —NHCOOR³, —NHCOS—R¹, —COOR¹, —OR¹, —N (R¹)₂, —SR¹, —OH, —NH₂, —NHR¹,

where, in R′ and R″ independently of one another, R¹ and R² are alike or different and are a C₁-C₂₀-alkyl-, C₃-C₂₀-cycloalkyl, -aryl, C₇-C₁₈-aralkyl radical, oligo-/polyethylene glycols and/or
-propylene glycols and R³ has one of the definitions of R¹ or is a polyester radical or a polyamide radical, and m corresponds to an integer from 1 to 5000, and/or of formula (II)

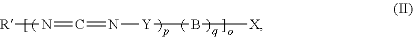

where
Y=C₁-C₁₈-alkylene, C₅-C₁₈-cycloalkylene, arylene, C₇-C₁₈-aralkylene,
p=an integer from 1 to 500, preferably 1 to 100,
B=—NH—COO—Z—, —NH—COO—Z—, —NH—COS—Z—,
a=an integer from 1 to 500, preferably 1 to 100,
o=an integer from 1 to 500, preferably 1 to 100,
X═H, —OH, —SH, —NH₂, —OR¹, —N(R¹)₂, —SR¹, —NHR¹, NR¹R², —OCO—NH—R′, NH CO—, —NH—R′, —S—CO—NH—R′
R′=C₁-C₁₈-alkyl, C₅-C₁₈-cycloalkyl, aryl, C₇-C₁₈-aralcyl
—R′″—NH—COS—R¹, —R′″—COOR¹, —R′″—OR¹, —R′″-N(R¹)₂,
—R′″-SR¹, —R′″—OH, —R′″—NH₂, —R′″—NHR1, —R′″-epoxy,
R′″-NCO, —R′″—NHCONHR¹, —R′″—NHCONR¹R² or —R′″—NH—COOR^{S},
where
R¹ and R² are alike or different and a C₁-C₂₀ alkyl, C₃-C₂₀-cycloalkyl, aryl, C₇-C₁₈-arylkyl radical, oligo-/polyethylene glycols and/or propylene glycols and R³ has one of the definitions of R¹ or is a polyester radical or a polyamide radical, such as, for example acetate- or butyl- and/or benzoic ester, R′″ is an aromatic and/or araliphatic radical,
Z=Y, -polyester-, -polyether- and/or -polyamide-,
   and which optionally comprise further additives,
   and the further layer or layers of material is/are placed onto this layer of adhesive and the layer or layers of adhesive is/are cured.

In relation to the preferred embodiment of R′″ reference is made to the recitations above.

The carbodiimides preferably are at least one of the compounds of the formulae (I), (II) and/or (III) already described earlier on above, or are biobased carbodiimides which are obtainable from the reaction of at least one carbodiimide of the formula (I) and/or (II) which possesses at least one free N—C—O functionality with at least one H-acidic compound isolated from renewable raw materials or prepared therefrom and/or with a hydroxycarboxylic ester having between 2 and 24 carbon atoms.

In this connection reference is made to the above-stated definitions of the compounds of the formulae (I), (II) and/or (III) and (IV) the above-stated definitions of the biobased compounds.

In order to prepare surfaces for adhesive bonding, diverse possibilities for pre-treatment are known. Generally speaking, the layer of material ought first to be grease-free before being cleaned further by other pre-treatment methods. In order to ensure this, cleaning steps, for example with solvents, or preliminary oven drying, are possible. For high-performance adhesive bonds there are further methods such as, for example, flaming, low-pressure plasma treatment or atmospheric-pressure plasma treatment, and the corona discharge technique. A further option is pre-treatment with adhesion promoters (primers, adhesion primers).

In a further embodiment of the invention, the layer of material is pre-treated before the layer of adhesive is knife-coated on.

In one preferred embodiment of the invention, curing takes place at temperatures between 20 and 100° C., optionally at pressures between 1 and 50 bar.

The thickness of the knife-coated layer of adhesive is preferably 10 to 250 μm.

Knife-coating may take place using machines, such as with conventional laminating machines, for example. Particularly appropriate is the application of the layer of adhesive in the liquid state to the layer of material that is to be bonded, preferably a foil, such as a foil of plastic or of metal, for example.

Typical processing temperatures are, for example, about 25° C. to 130° C., preferably up to 75° C. in the case of the production of flexible packaging films.

The process described can be repeated a number of times, allowing the production of foil assemblies composed of more than two bonded layers of material.

The present invention further provides for the use of polymeric systems selected from the group consisting of polyamides, copolyamides, polyolefins, ethylene-vinyl acetate copolymers, polyurethanes, thermoplastic polyurethanes (TPU), polyesters, polyacrylates and/or vinylpyrrolidone/vinyl acetate copolymers, polyester-urethanes, acrylates, polyethers and/or polyether-urethanes, which further comprise at least one carbodiimide or a mixture of two or more carbodiimides of the formulae (I), (II) and/or (III) and optionally further additives, for adhesively bonding at least 2 different layers of material for producing flexible packaging forms.

Use may likewise be made here also of compounds of the formula (I) and/or (II), which are obtainable from the reaction of at least one carbodiimide of formula (I) and/or (II) which possesses at least one free N—C—O functionality with at least one H-acidic compound which is isolated from renewable raw materials or prepared therefrom, and/or with a hydroxycarboxylic ester having 2-24 carbon atoms.

In relation to the characterization of the polymeric systems and of the carbodiimides of the formulae (I), (II) and/or (III) and also of the hydroxycarboxylic esters, reference is made to the recitations above.

The present invention further provides, accordingly, for the use of the flexible packaging of the invention for use in the food sector, for medical applications, such as infusion solutions, packaging of syringes, etc. for example, and for the packaging of industrial products.

The examples which follow serve to illustrate the invention, without having any limiting effect.

### WORKING EXAMPLES

The samples VV and 1-4 below were produced from the starting materials identified below:

Desmocoll® 140, a substantially linear hydroxy-polyurethane from BayerMaterial Science AG.

Baycoll® AS 2060, a polyester polyol with a low degree of branching from Bayer MaterialScience AG.

Desmodur® RFE, a solution of tris(p-isocyanatophenyl) thiophosphate in ethyl acetate.

Carbodiimide A, an oligomeric, aromatic carbodiimide having an N═C═N content of at least 12.5%, available from Rhein Chemie Rheinau GmbH under the name Stabaxol®P,

Carbodiimide B, a monomeric carbodiimide: Bis(2,6-diisopropylphenyl) carbodiimide having an N═C═N content of at least 10%, available from Rhein Chemie Rheinau GmbH under the name Stabaxol® I,

Carbodiimide C: Bis(2,6-diisopropylphenyl) carbodiimide (monomer, low fogging, low VOC (volatile organic compounds) fraction through reduced monomer content) having an N═C=N content of at least 10%, available from Rhein Chemie Rheinau GmbH under the name Stabaxol® I LF,

Carbodiimide D: a polymeric carbodiimide having an N═C═N content: 6-7.5% available from Rhein Chemie Rheinau GmbH under the name Stabaxol® P 200.

Carbodiimides A-D were employed in proportions such that the N═C═N content is the same in each of Examples 1-4.

The fractions indicated in Table 1 below are in phr.

TABLE 1
Quantities used for preparing the adhesives

| | | 1 | 2 | 3 | 4 |
|---|---|---|---|---|---|
| Component | VV | (inventive) | (inventive) | (inventive) | (inventive) |
| Desmocoll ® | 14 | 14 | 14 | 14 | 14 |
| 140 | | | | | |
| Baycoll ® AS | 7 | 7 | 7 | 7 | 7 |
| 2060 | | | | | |
| Desmodur ® | 4 | 4 | 4 | 4 | 4 |
| RFE | | | | | |
| Ethyl acetate | 75 | 75 | 75 | 75 | 75 |
| Carbodiimide A | x | 0.25 | x | x | x |
| Carbodiimide B | x | x | 0.32 | x | x |
| Carbodiimide C | x | x | x | 0.32 | x |
| Carbodiimide D | x | x | x | x | 0.48 |

The samples of adhesive were prepared as follows:

Version 1: 14 phr of Desmocoll® 140 were dissolved at 85° C. in 75 phr of anhydrous ethyl acetate. When the solution was cooled to room temperature, the other components identified in Table 1 were added.

Version 2: 14 phr of Desmocoll® 140 were dissolved at 85° C. in 75 phr of anhydrous ethyl acetate. When the solution was cooled to room temperature, the other components identified in Table 1, except for Desmodur® RFE, were added.

After this addition, the batch was heated to 80° C. over a period of 5 hours, and then Desmodur® RFE was added.

### Production of Specimens (Peel Samples) Using Samples VV and 1-4, Prepared According to Versions 1 or 2:

The peel samples were produced using a commercial PET film from Goodfellow GmbH with a thickness of 23 μm, with an aluminium foil from Goodfellow GmbH with a thickness of 100 □m. The films and foils were not pre-treated.

The above adhesive samples VV and 1-4, prepared according to versions 1 and 2, respectively, were knife-coated, each in a wet film thickness of 50 □m onto the aluminium foils. After storage for 10 minutes the PET film is placed onto each of the layers of adhesive, and the assemblies are cured at 40° C. for an hour under an applied pressure of 3 kilograms.

Test specimens with a size of 20×30 cm are produced from these PET film-aluminium foil assemblies.

The outstanding long-term stability of the adhesive layer having at least 2 layers of foils (PET film-aluminium foil) is demonstrated by means of the roller peel test, described below, before and after ageing.

In the roller peel test, the peel resistance of an adhesive is measured in N/cm or N/mm. In this test, the end of the PET film-aluminium foil assemblies was bent around by 90° in each case, such that the sample then looked like a T-piece. The free ends were clamped into a universal testing machine and pulled apart. The values for PET film-aluminium foil assemblies prepared via versions 1 and 2, respectively, are set out in Tables 2-4 below.

TABLE 2
according to version 1 (without heat treatment):

| Time | VV | | | | |
|---|---|---|---|---|---|
| [h] | [N/mm] | 1 [N/mm] | 2 [N/mm] | 3 [N/mm] | 4 [N/mm] |
| 0 | 0.01 | 0.04 | 0.04 | 0.03 | 0.03 |
| 168 | 0.08 | 0.11 | 0.15 | 0.14 | 0.15 |
| 500 | 0.02 | 0.15 | 0.14 | 0.14 | 0.12 |
| 1000 | 0.01 | 0.17 | 0.22 | 0.02 | 0.02 |

TABLE 3
according to version 1 (heat-treated after 60 h/45° C.)

| Time [h] | VV [N/mm] | 2 [N/mm] | 3 [N/mm] | 4 [N/mm] |
|---|---|---|---|---|
| 0 | 0.08 | 0.10 | 0.07 | 0.03 |
| 168 | 0.16 | 0.15 | 0.15 | 0.09 |
| 500 | 0.17 | 0.18 | 0.18 | 0.10 |
| 1000 | 0.02 | 0.27 | 0.09 | 0.11 |

TABLE 4
according to version 2 (without heat treatment):

| | VV | | | | |
|---|---|---|---|---|---|
| Time | [N/mm] | 1 [N/mm] | 2 [N/mm] | 3 [N/mm] | 4 [N/mm] |
| 0 | 0.01 | 0.03 | 0.03 | 0.03 | 0.02 |
| 168 | 0.08 | 0.08 | 0.11 | 0.14 | 0.12 |
| 500 | 0.02 | 0.10 | 0.15 | 0.16 | 0.11 |
| 1000 | 0.01 | 0.11 | 0.10 | 0.10 | 0.11 |
| 2040 | 0 | 0.01 | 0.02 | 0.02 | 0.06 |

All of the inventive samples exhibited positive results in the roller peel test over a very long period. This means that the inventive samples exhibit a significantly increased stability as compared with the prior art (VV) and hence possess a longer service life. This is also evidence of the increased stability with respect to hydrolysis.

1. A flexible packaging form comprising:
a first layer of material and a second layer of material, wherein the first layer and the second layer are joined together by means of at least one adhesive layer deposited between the first layer and the second layer, wherein the at least one adhesive layers comprises a carbodiimide of the formula (I)
R′—(—N═C═N—R′″—)ₘ—R″ (I),
in which
R′″ is an aromatic and/or araliphatic radical and, where m≧1, R′″ within the molecule is alike or different and, in the case of different combinations, each of the aforementioned radicals may be combined arbitrarily with one another,
R′″ in the case of an aromatic radical or araliphatic radical can carry no substituents, or in at least one ortho-position to the aromatic carbon atom which carries the carbodiimide group, can carry aliphatic and/or cycloaliphatic substituents having at least 2 carbon atoms, which may also carry heteroatoms,
R′=C₁-C₁₈-alkyl, C₅-C₁₈-cycloalkyl, aryl, C₇-C₁₈-aralkyl, —R—NHCOS—R¹, —R—COOR¹, —R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or
—R—NHCOOR³, where R=aromatic, aliphatic, cycloaliphatic and/or araliphatic radical,
R″=H, —N═C═N-aryl, —N═C═N-alkyl, —N═C═N-cycloalkyl, —N═C═N-aralkyl, —NCO, —NHCONHR¹, —NHCONR¹R², —NHCOOR³, —NHCOS—R¹, —COOR¹, —O R¹, —N(R¹)₂, —SR¹, —OH, —NH₂, —NHR¹,
where, in R′ and R″ independently of one another, R¹ and R² are alike or different and are a C₁-C₂₀-alkyl-, C₃-C₂₀-cycloalkyl, -aryl, C₇-C₁₈-aralkyl radical, oligo-/polyethylene glycols and/or -propylene glycols and R³ has one of the definitions of R¹ or is a polyester radical or a polyamide radical, and m corresponds to an integer from 1 to 5000,
and/or at least one carbodiimide of formula (II) 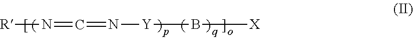
where
Y=C₁-C₁₈-alkylene, C₅-C₁₈-cycloalkylene, arylene, C₇-C₁₈-aralkylene
p=an integer from 1 to 500, preferably 1 to 100,
B=—NH—CO—NH—Z—, —NH—COO—Z—, —NH—COS—Z—,
q=an integer from 1 to 500, preferably 1 to 100,
o=an integer from 1 to 500, preferably 1 to 100,
X=H, —OH, —SH, —NH₂, —OR¹, —N(R¹)₂, —SR¹, —NHR¹, NR¹R², —OCO—NH—R′, NH CO—, —NH—R′, —S—CO—NH—R′
R′=C₁-C₁₈-alkyl, C₅-C₁₈-cycloalkyl, aryl, C₇-C₁₈-aralkyl
—R′″-NH—COS—R¹, —R′″-COOR¹, —R′″—OR¹, —R′″—N(R¹)₂,
R′″-SR¹, —R′″—OH, —R′″—NH₂, —R′″—NHR¹, —R′″-epoxy,
R′″—NCO, —R′″—NHCONHR¹, —R′″—NHCONR¹R² or
—R′″—NH—COOR³,
where
R¹ and R² are alike or different and a C₁-C₂₀ alkyl, C₃-C₂₀-cycloalkyl, aryl, C₇-C₁₈-arylkyl radical, oligo-/polyethylene glycols and/or propylene glycols and R³ has one of the definitions of R¹ or is a polyester radical or a polyamide radical, such as, for example acetate- or butyl- and/or benzoic ester R′″ is an aromatic and/or araliphatic radical and
Z=Y, -polyester-, -polyether- and/or -polyamide-.

2. The flexible packaging forms according to claim 1, wherein the first layer of material and the second layer of material, independently of one another, are selected form the group consisting of polyethylene terephthalate, polyolefins, polyamides, aluminium foils, and combinations thereof.

3. The flexible packaging forms according to claim 1, wherein the at least one adhesive layer comprises polymeric systems selected from the group consisting of polyamides, copolyamides, polyolefins, ethylene-vinyl acetate copolymers, polyurethanes, thermoplastic polyurethanes, polyesters, polyacrylates and/or vinylpyrrolidone/vinyl acetate copolymers, polyester-urethanes, acrylates, polyethers, polyether-urethanes, and combinations thereof.

4. The flexible packaging form according to claim 1, wherein the at least one adhesive layer is solvent-based, water-based, solvent-free, UV curing, or mixtures thereof.

5. The flexible packaging forms according to claim 1, wherein the carbodiimide is a compound of the general formula (III), 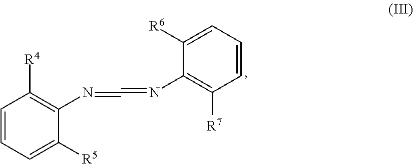
in which R⁴ to R⁷ independently of one another are linear or branched C₁- to C₂₀-alkyl, C₃- to C₂₀-cycloalkyl, C₆-C₁₅-aryl or a C₆-C₁₅-aralkyl radical, which optionally may also contain heteroatoms.

6. The flexible packaging forms according to claim 1, wherein the carbodiimide is formed from the reaction of at least one carbodiimide of the formula (I) or (II), which possesses at least one free N—C—O functionality with at least one H-acidic compound which is isolated from renewable raw materials or prepared therefrom, and/or with a hydroxycarboxylic ester having 2-24 carbon atoms.

7. A method for producing the flexible packaging forms according to claim 1, comprising:
applying the adhesive layer by knife-coating to the surface of the first layer of material, said adhesive layer comprising a polymeric systems selected from the group consisting of polyamides, copolyamides, polyolefins, ethylene-vinyl acetate copolymers, polyurethanes, thermoplastic polyurethanes, polyesters, polyacrylates, vinylpyrrolidone/vinyl acetate copolymers, polyester-urethanes, acrylates, polyethers, polyether-urethanes, and mixtures thereof, said adhesive layer further comprises a carbodiimide or a mixture of two or more carbodiimides of the formula (I)
R′—(—N═C═N—R′″—)ₘ—R″ (I),
in which
R′″ is an aromatic and/or araliphatic radical and, where m≧1, R′″ within the molecule is alike or different and, in the case of different combinations, each of the aforementioned radicals may be combined arbitrarily with one another,
R′″ in the case of an aromatic radical or araliphatic radical can carry no substituents, or in at least one ortho-position to the aromatic carbon atom which carries the carbodiimide group, can carry aliphatic and/or cycloaliphatic substituents having at least 2 carbon atoms, which may also carry heteroatoms,
R′=C₁-C₁₈-alkyl, C₅-C₁₈-cycloalkyl, aryl, C₇-C₁₈-aralkyl, —R—NHCOS—R¹, —R—COOR¹, —R—OR¹, —R—N(R¹)₂, —R—SR¹, —R—OH, —R—NH₂, —R—NHR¹, —R-epoxy, —R—NCO, —R—NHCONHR¹, —R—NHCONR¹R² or
—R—NHCOOR³, where R=aromatic, aliphatic, cycloaliphatic and/or araliphatic radical,
R″=H, —N═C═N-aryl, —N═C═N-alkyl, —N═C═N-cycloalkyl, —N═C═N-aralkyl(, —NCO, —NHCONHR¹, —NHCONR¹R², —NHCOOR³, —NHCOS—R¹, —COOR¹, —O R¹(, —N(R¹)₂, —SR¹, —OH, —NH₂, —NHR¹,
where, in R′ and R″ independently of one another, R¹ and R² are alike or different and are a C₁-C₂₀-alkyl-, C₃-C₂₀-cycloalkyl, -aryl, C₇-C₁₈-aralkyl radical, oligo-/polyethylene glycols and/or -propylene glycols and R³ has one of the definitions of R¹ or is a polyester radical or a polyamide radical, and m corresponds to an integer from 1 to 5000,
and/or of formula (II) 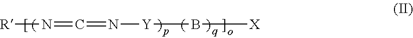
where
Y=C₁-C₁₈-alkylene, C₅-C₁₈-cycloalkylene, arylene, C₇-C₁₈-aralkylene
p=an integer from 1 to 500, preferably 1 to 100,
B=—NH—CO—NH—Z—, —NH—COO—Z—, —NH—COS—Z—,
q=an integer from 1 to 500, preferably 1 to 100,
o=an integer from 1 to 500, preferably 1 to 100,
X=H, —OH, —SH, —NH₂, —OR¹, —N(R¹)₂, —SR¹, —NHR¹, NR¹R², —OCO—NH—R′, NH CO—, —NH—R′, —S—CO—NH—R′
R′=C₁-C₁₈-alkyl, C₅-C₁₈-cycloalkyl, aryl, C₇-C₁₈-aralkyl
—R′″—NH—COS—R¹, —R′″-COOR¹, —R′″—OR¹, R′″—N(R¹)₂,
R′″-SR¹, —R′″—OH, —R′″—NH₂, —R′″—NHR1, —R′″-epoxy,
R′″—NCO, —R′″—NHCONHR¹, —R′″—NHCONR¹R² or
—R′″—NH—COOR³,
where
R¹ and R² are alike or different and a C₁-C₂₀ alkyl, C₃-C₂₀-cycloalkyl, aryl, C₇-C₁₈-arylkyl radical, oligo-/polyethylene glycols and/or propylene glycols and R³ has one of the definitions of R¹ or is a polyester radical or a polyamide radical, R′″ is an aromatic and/or araliphatic radical and
Z=Y, -polyester-, -polyether- and/or -polyamide-,
and applying the second layer of material onto the adhesive layer, and
curing the adhesive layer.

8. (canceled)

9. The process according to claim 7, wherein the carbodiimide is formed from the reaction of at least one carbodiimide of formula (I) and/or (II) which possesses at least one free N—C—O functionality with at least one H-acidic compound which is isolated from renewable raw materials or prepared therefrom, and/or with a hydroxycarboxylic ester having 2-24 carbon atoms.

10. The product of adhesively bonding at least 2 different layers of material for flexible packaging forms according to claim 1 for foods, medical applications and/or industrial products.

11. The flexible packaging form according to claim 1, wherein the at least one adhesive layer comprises a mixture of two or more carbodiimides of the formula (I).
